(19) United States
(12) Patent Application Publication
(10) Pub. No.: US 2026/0169434 A1
(43) Pub. Date: Jun. 18, 2026

(54) VIBRATORY-ACTUATED DRIVE DEVICE, IN PARTICULAR FOR HOROLOGY

(71) Applicant: The Swatch Group Research and Development Ltd, Marin-Epagnier (CH)

(72) Inventors: Jean-Jacques BORN, Morges (CH); Mohammad Hussein KAHROBAIYAN, Boudevilliers (CH); Jonathan MEYER, Bienne (CH); Julien CHRISTAN, Bienne (CH)

(73) Assignee: The Swatch Group Research and Development Ltd, Marin-Epagnier (CH)

(21) Appl. No.: 19/386,912

(22) Filed: Nov. 12, 2025

(30) Foreign Application Priority Data
Dec. 17, 2024 (EP) 24220733.0

(51) Int. Cl. G04B 17/32

(52) U.S. Cl. CPC G04B 17/32

(57) ABSTRACT

A vibratory-actuated drive device (1, 10, 20, 30, 40) for a horology movement, the drive device (1, 10, 20, 30, 40) including a rotationally mobile organ (2, 12) with toothing (3, 33) enabling it to be set in motion, at least two mobile oscillators (4, 5) arranged to mechanically engage with the mobile organ (2, 12), each mobile oscillator (4, 5) being configured to oscillate at a different predetermined frequency when the drive device (1, 10, 20, 30, 40) vibrates at said predetermined frequency, each mobile oscillator (4, 5) being provided with a tooth (21) capable of striking the toothing (3) on the mobile organ (2, 12) to drive it when the oscillator (4, 5) oscillates at its predetermined frequency.

### CROSS-REFERENCE TO RELATED APPLICATIONS

This application claims priority to European Patent Application No. 24220733.0 filed Dec. 17, 2024, the entire contents of which are incorporated herein by reference.

### TECHNICAL FIELD OF THE INVENTION

The invention relates to the field of point-actuatable drive devices, and more specifically to the field of vibratory-actuated drive devices, in particular for horology.

### TECHNOLOGICAL BACKGROUND

In gear mechanisms, it may be necessary to use a point-actuatable drive device. More specifically, in the horology field, there are mechanisms for timing a particular horology module, for example the time or the date, or for setting the rate of the movement.

These mechanisms are point-actuated and mechanically engage mobiles and/or toothed wheels, or other types of components.

To actuate them, these mechanisms either require a device accessible from outside the timepiece, such as a winding crown and stem for setting the time, or they require the case of the timepiece to be opened to access the timepiece module, for example when setting the rate.

Actuation from outside the case makes the movement more complex, as components have to be added to the movement to allow access to the horology module to be actuated. The case must also be water-resistant.

Moreover, opening the case changes the pressure inside the case, which has negative repercussions on the rate of the regulating organ.

There are drive devices that can be actuated from outside the case, without opening the case. For example, document DE1720495 presents a magnetic actuator, while document CH504030 presents a thermal actuator and document EP3118693 presents a photo actuator.

However, these drive devices do not offer sufficient setting precision, particularly for changing the rate.

Moreover, these known drive devices can be unintentionally actuated by the user or wearer of the timepiece, thereby potentially affecting its adjustment.

### SUMMARY OF THE INVENTION

The present invention aims to remedy all or part of the drawbacks mentioned above by providing a drive device for accurate setting that can be actuated from outside a case.

To this end, the invention relates to a vibratory-actuated drive device, in particular for a horology movement, the drive device comprising a rotationally mobile organ with toothing enabling it to be set in motion.

The invention is remarkable in that the drive device comprises at least two mobile oscillators arranged to mechanically engage with the mobile organ, each mobile oscillator being configured to oscillate at a different predetermined frequency when the drive device vibrates at said predetermined frequency, each mobile oscillator being provided with a tooth capable of striking the toothing on the mobile organ to drive it when the oscillator oscillates at its predetermined frequency.

With the invention, a drive device is provided that makes it possible to drive a mobile organ via vibratory actuation. In fact, simply vibrating the drive device at predetermined frequencies actuates the oscillators and drives the mobile organ. As such, it offers new perspectives and new potential configurations, particularly in horology movements.

Moreover, such a device can be actuated from outside a case, for example in the case of a timepiece for which it is desirable to adjust the setting without opening the case. The drive device can in fact be actuated by vibrating the entire timepiece with the case closed. Furthermore, the risk of unintentional actuation is very low.

According to a particular embodiment of the invention, the drive device comprises a third mobile oscillator configured to oscillate at a predetermined frequency different from the frequencies of the other two oscillators.

Around a particular embodiment of the invention, each oscillator comprises an inertial body with the tooth and a flexible guide as a resilient return means for said inertial body.

According to a particular embodiment of the invention, the flexible guide comprises a flexible blade joining the inertial body to a fixed support.

According to a particular embodiment of the invention, the flexible guide comprises two uncrossed flexible blades connecting the inertial body to a fixed support.

According to a particular embodiment of the invention, the flexible guide comprises two pairs of flexible blades, a first pair of flexible blades joining an intermediate element to a fixed support, and a second pair of flexible blades joining the inertial body to the intermediate element.

According to a particular embodiment of the invention, the teeth of each oscillator are positioned at one end of the body and are directed towards the toothing on the mobile organ.

According to a particular embodiment of the invention, the oscillators are arranged around the mobile organ, the toothing being arranged at the periphery of the mobile organ.

According to a particular embodiment of the invention, the mobile organ comprises a ring with internal toothing, the oscillators being arranged inside the ring.

According to a particular embodiment of the invention, the drive device functions by sequences of consecutive vibrations at said predetermined frequencies, so that each oscillator drives the mobile organ in turn.

According to a particular embodiment of the invention, the mobile organ is rotationally mobile in two opposite directions of rotation.

The invention also relates to a horology movement comprising such a drive device.

The invention further relates to a timepiece comprising such a horology movement.

The invention also relates to a method for actuating a mobile organ on such a timepiece or such a horology movement, the method comprising a step in which the timepiece or the horology movement is vibrated by a vibratory system configured to vibrate it sequentially at predetermined frequencies, the step consisting in applying a sequence of vibrations at the predetermined frequency to each oscillator in turn, in order to drive the mobile organ.

According to a particular embodiment of the invention, the oscillators are vibrated sequentially in a first order to turn the mobile organ in a first direction, and the oscillators are vibrated in a second order different from the first order to turn the mobile organ in a second direction opposite to the first direction.

According to a particular embodiment of the invention, the method comprises a prior step in which the angle of rotation and/or the direction of rotation of the mobile organ is determined, and a step in which the sequence of vibrations to be applied to the movement and/or to the timepiece in order to achieve it is determined.

### BRIEF DESCRIPTION OF THE FIGURES

The purposes, advantages and characteristics of the present invention will become apparent on reading several embodiments provided solely by way of non-limiting examples, with reference to the appended drawings in which:

FIG. 1 shows a schematic top view of a vibratory-actuated drive device according to a first embodiment of the invention,

FIG. 2 shows a schematic top view of a vibratory-actuated drive device according to a second embodiment of the invention,

FIG. 3 shows a schematic top view of a vibratory-actuated drive device according to a third embodiment of the invention,

FIG. 4 shows a schematic top view of a vibratory-actuated drive device according to a fourth embodiment of the invention,

FIG. 5 shows a schematic top view of a vibratory-actuated drive device according to a fifth embodiment of the invention, and

FIG. 6 shows a schematic view of the steps in which the oscillators are actuated to drive the mobile organ in one direction and in the other direction.

### DETAILED DESCRIPTION OF THE INVENTION

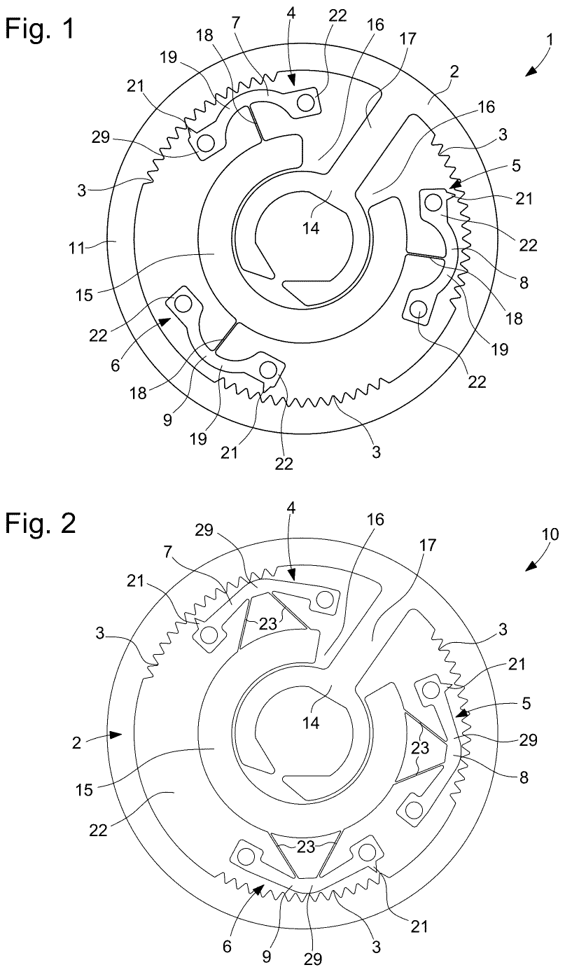

FIGS. 1 to 5 show various embodiments of a vibratory-actuated drive device 1, 10, 20, 30, 40, in particular for a horology movement. Such a vibratory-actuated drive device 1, 10, 20, 30, 40 can, for example, be used to drive a setting mechanism on a horology movement, for example to set the rate of the horology movement, or in a device for displaying the date, the day of the week or the month, or even a moon phase.

In FIG. 1, the first embodiment of the drive device 1 comprises a rotationally mobile organ 2 with toothing 3 enabling it to be set in motion, preferably rotationally. The mobile organ 2 comprises an outer ring 11 joined to a rotating central arbor 14.

The mobile organ 2 has internal toothing 3 inside the ring. The toothing 3 is discontinuous on the mobile organ 2. The mobile organ 2 is joined to the gears of a horology movement, for example, by means of the central arbor 14, enabling the rate of the regulating organ to be set, or to a device for displaying the date, the day of the week or of the month, or even a moon phase.

According to the invention, the drive device 1 comprises three mobile oscillators 4, 5, 6, arranged to mechanically engage with the mobile organ 2 so as to turn it. The oscillators 4, 5, 6 are arranged inside the ring of the mobile organ 2, for example with an angle of 120° between two consecutive oscillators 4, 5, 6.

The drive device 1 comprises a fixed support 15 on which the mobile oscillators 4, 5, 6 are mounted. The fixed support 15 is secured to the plate on the movement, for example.

The fixed support 15 is in the form of an open ring, the opening 16 enabling the passage of an arm 17 joining the outer ring 11 to the central arbor 14 on the mobile organ 2.

The oscillators 4, 5, 6 comprise an inertial body 7, 8, 9 and resilient means for returning said inertial body 7, 8, 9. The resilient return means enable it to oscillate. Preferably, the resilient return means are flexible guides.

The inertial bodies 7, 8 and 9 are in the form of an elongated balance comprising a main arm 19 and two centrifugal weights 22, one at each end of the main arm 19. The main arm 19 has a rounded shape.

The resilient return means comprise a flexible guide provided with a flexible blade 18 elastically joining the middle of one of the inertial bodies 7, 8, 9 to the fixed support 15. The flexible blades 18 are radially arranged between the inertial bodies 7, 8, 9 and the fixed support 15.

Each mobile oscillator 4, 5, 6 comprises a tooth 21 suitable for engaging the toothing 3 on the mobile organ so as to actuate it. The inertial body 7, 8, 9 is provided with tooth 21, arranged for example on an inertia block 22 at one end of the main arm 19, or the tooth 21 is made of the same material as the main arm 19.

Each mobile oscillator 4, 5, 6 is configured to oscillate at a different predetermined frequency. The first oscillator 4 oscillator at a first predetermined frequency, the second oscillator 5 oscillator at a second predetermined frequency, and the third oscillator 6 oscillator at a third predetermined frequency. The three frequencies are different from one another so that each oscillator 4, 5, 6 can be actuated separately from the others.

The f predetermined frequencies of each oscillator 4, 5, 6 are determined from the following equation:

$$f = \frac{1}{2 π} \sqrt{\frac{k}{J} ,}$$

wherein k is the rigidity of the flexible guide and J is the inertia of the inertial body 7, 8, 9.

To obtain different frequencies, the inertial bodies 7, 8 and 9 preferably have different inertias, and/or the rigidity of the flexible guides is different between each oscillator.

For example, predetermined frequencies of 300 Hz, 330 Hz and 360 Hz are chosen for the three oscillators 4, 5 and 6. Accordingly, when the drive device 1, 10, 20, 30 40 is vibrated at one of these frequencies, the oscillator corresponding to this frequency starts to oscillate strongly.

The oscillation of the oscillator 4, 5, 6 enables the tooth 21 on the inertial body 7, 8, 9 to engage with the toothing 3 on the mobile organ 2 at each oscillation, so that the tooth 21 strikes the toothing 3 to turn the mobile organ 2.

Thus, when the drive device 1 vibrates at one of the predetermined frequencies, the oscillator 4, 5, 6 with the corresponding natural frequency starts to oscillate due to the phenomenon of resonance by base excitation, whereas the other oscillators 4, 5, 6 do not vibrate, or do not vibrate sufficiently for their tooth 21 to reach the toothing 3 on the mobile organ 2.

The arrangement of the teeth 21 on each oscillator 4, 5, 6 relative to the toothing 3 on the mobile organ 2 is chosen so that it is in a position to strike the toothing 3 on the mobile organ 2 to turn it. Thus, when an oscillator is actuated, its tooth 21 penetrates the toothing 3 to pull on the toothing on the mobile organ 2, 12.

In particular, the distance between the teeth on the oscillators 4, 5, 6 is chosen to engage with the toothing 3, which has teeth with a predetermined number and dimensions. When an oscillator 4, 5, 6 is actuated, the tooth 21 is offset relative to the centre of the interval between two teeth in the toothing 3. When the tooth 21 penetrates the interval, the tooth presses on one side of the toothing 3 on the mobile organ 2 so as to penetrate as far as possible into the interval. This forces the mobile organ 2 to turn.

The drive device 1 can be actuated by sequences of consecutive vibrations at said predetermined frequencies, so that each tooth 21 on the oscillators 4, 5, 6 drives the mobile organ 2 in turn.

Each oscillator 4, 5, 6 thus turns the mobile organ one notch at a time to actuate the mobile organ 2.

The drive device 10 in FIG. 2 is similar to the first embodiment. The flexible guide on the resilient return means joining the inertial bodies 7, 8, 9 to the fixed support 15 comprises a pair of tapered blades 23 extending from each inertial body 7, 8, 9 to the fixed support 15. In addition, the main arms 29 are elbow-shaped. The drive device 10 functions in the same way as the first embodiment.

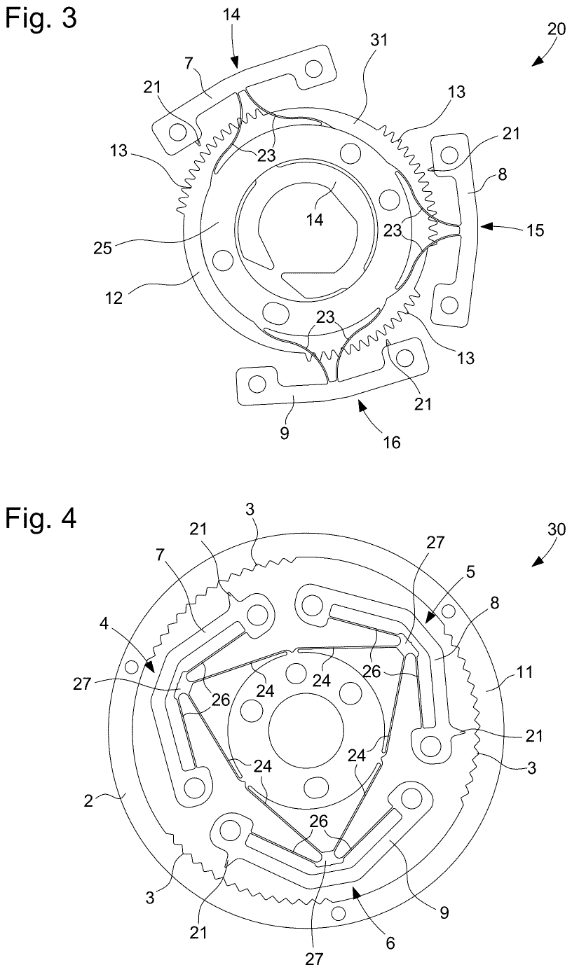

In the third embodiment of the drive device 20 in FIG. 3, the three oscillators 4, 5 and 6 are spaced around the mobile organ 12. The regulating organ 12 comprises an inner ring 31 rotationally mounted around the central arbor 14. The inner ring 31 comprises toothing 13 extending around the inner ring 31. The flexible guide on the resilient return means joining the inertial bodies 7, 8, 9 to the fixed support 15 comprises a pair of tapered blades 23 extending from each inertial body 7, 8, 9 to the fixed support 25. The drive device 20 functions in the same way as the first and second embodiments.

FIG. 4 shows a fourth embodiment of a drive device 30 comprising an outer ring 12 and oscillators 4, 5, 6 fitted with a flexible guide comprising a double pivot with uncrossed blades. A first pivot with two uncrossed blades 24 joins the fixed support 15 to an intermediate element 27, moving towards each other, and a second pivot with two uncrossed blades 26 joins the intermediate element 27 to the inertial body 7, 8, 9, moving away from each other. The outer ring 11 is connected directly to gear means.

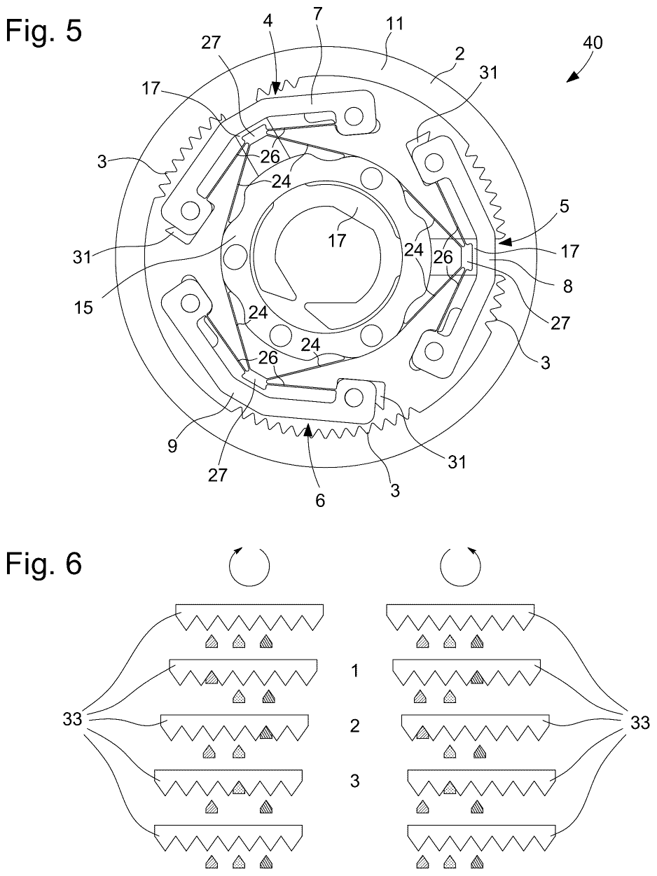

The fifth embodiment of the drive device 40 in FIG. 5 is similar to the one in the fourth embodiment. The oscillators 4, 5 and 6 are raised relative to the outer bow 11. The inertial bodies 7, 8, 9 are provided with a tooth 31 arranged beneath them. The outer ring 11 is joined by two arms 17 to the central arbor 14.

In a variant embodiment not shown in the figures, the toothing 3, 13 is continuous on the mobile organ and forms a circle, in particular for a drive device in which the mobile organ turns in one direction only. As a result, the mobile organ can turn in the same direction indefinitely.

In a variant embodiment not shown in the figures, a drive device comprises only two oscillators for turning the mobile organ. Such an embodiment can turn the regulating organ in only one direction, whereas with three oscillators the drive device can turn the mobile organ in opposite directions by choosing a different sequential order for activating the oscillators.

The invention also relates to a method for actuating a vibratory-actuated drive device 1, 10, 20, 30, 40, as described above, the drive device 1, 10, 20, 30, 40 being arranged in a horology movement, preferably mounted in a timepiece.

The method comprises a step in which the horology movement or timepiece is vibrated by a vibratory system configured to vibrate the horology movement or timepiece at a predetermined frequency.

This step consists of applying a series of vibrations at each predetermined frequency in turn so as to successively actuate the oscillators on the drive device 1, 10, 20, 30, 40. The vibrations preferably have low amplitudes to avoid damaging the other components in the movement.

Each vibration is carried out for a time interval chosen so as to ensure that the tooth 21 on the oscillator 4, 5, 6 has reached the toothing 3, 13 on the mobile organ 2, 12. This time interval is preferably the same for the oscillations of each oscillator 4, 5, 6. As a variant, the time interval is different for the oscillations of each oscillator 4, 5, 6, particularly if the oscillations are very different between the oscillators 4, 5, 6.

FIG. 7 is a schematic view with continuous toothing 33, in which the teeth 21 on the oscillators are shown next to each other for the sake of simplicity. It shows two sequences for turning the mobile organ in opposite directions.

The order of the vibration frequencies corresponds to the direction of rotation of the mobile organ 2. Thus, on the left, if the first oscillator, then the third oscillator and lastly the second oscillator are vibrated one after the other, and by repeating this sequence, the mobile organ 2 turns in a first direction.

To turn it in the other direction, to the right in FIG. 7, the oscillators are vibrated one after the other in a different order, for example the third oscillator, then the first oscillator and lastly the second oscillator, repeating this sequence.

Preferably, the method comprises a prior step in which the angle of rotation and/or the direction of rotation of the mobile organ is determined, and a step in which the sequence of vibrations to be applied to the movement and/or to the timepiece in order to achieve it is determined.

When setting a rate, the method comprises a prior step in which the rate of the movement is determined, the difference in rate of the horology movement is measured, then the direction of rotation and the angle of rotation of the mobile organ corresponding to the correction of the rate are determined, and the timepiece or the horology movement is vibrated at said predetermined frequencies to achieve the desired correction.

Such a method is implemented using a vibratory-actuated system, the vibratory system comprising a mobile workpiece holder for the timepiece or horology movement, means for holding the workpiece holder configured to be able to agitate the workpiece holder by vibrating it at different frequencies, and means for controlling the holding means configured to vibrate the workpiece holder at said predetermined frequencies.

All that is required is to deposit the timepiece or the horology movement on the workpiece holder and to program the control means to sequentially vibrate the movement or the timepiece successively at said predetermined frequencies so as to drive the mobile organ 2, 12 of the drive device 1, 10, 20, 30, 40.

Naturally, the invention is not limited to the embodiments of the drive device described with reference to the figures, and variants could be considered without departing from the scope of the invention.

1. A vibratory-actuated drive device for a horology movement, the drive device comprising a rotationally mobile organ with toothing enabling it to be set in motion, wherein the drive device comprises at least two mobile oscillators arranged to mechanically engage with the mobile organ, each mobile oscillator being configured to oscillate at a different predetermined frequency when the drive device vibrates at said predetermined frequency, each mobile oscillator being provided with a tooth capable of striking the toothing on the mobile organ to drive it when the oscillator oscillates at its predetermined frequency.

2. The drive device according to claim 1, further comprising a third mobile oscillator configured to oscillate at a third predetermined frequency different from the frequencies of the other two oscillators.

3. The drive device according to claim 1, wherein each oscillator comprises an inertial body with the tooth and a flexible guide as a resilient return means for said inertial body.

4. The drive device according to claim 3, wherein the flexible guide comprises a flexible blade joining the inertial body to a fixed support.

5. The drive device according to claim 3, wherein the flexible guide comprises two uncrossed flexible blades joining the inertial body to a fixed support.

6. The drive device according to claim 3, wherein the flexible guide comprises two pairs of flexible blades, a first pair of flexible blades joining an intermediate element to a fixed support, and a second pair of flexible blades joining the inertial body to the intermediate element.

7. The drive device according to claim 3, wherein the teeth on each oscillator are positioned at one end of the inertial body and are directed towards the toothing on the mobile organ.

8. The drive device according to claim 1, wherein the oscillators are arranged around the mobile organ, the toothing being arranged on the periphery of the mobile organ.

9. The drive device according to claim 1, wherein the mobile organ comprises a ring with internal toothing, the oscillators being arranged inside the ring.

10. The drive device according to claim 1, wherein the drive device functions by sequences of consecutive vibrations at said predetermined frequencies, so that each oscillator drives the mobile organ in turn.

11. The drive device according to claim 1, wherein the mobile organ is rotationally mobile in two opposite rotational directions.

12. A horology movement comprising the drive device around claim 1.

13. A timepiece comprising the horology movement according to claim 12.

14. A method for actuating a drive device according to claim 1, the drive device being arranged in a horology movement and/or a timepiece, the method comprising a step in which the movement and/or the timepiece is vibrated by a vibratory system configured to vibrate the movement or the timepiece sequentially at predetermined frequencies, the step including applying a sequence of vibrations to the timepiece at the predetermined frequency of each oscillator in turn so as to drive the mobile organ.

15. The method for actuating a drive device according to claim 14, wherein the oscillators are vibrated sequentially in a first order so as to turn the mobile organ in a first direction, and wherein the oscillators are vibrated in a second order different from the first so as to turn the mobile organ in a second direction opposite to the first direction.

16. The method for actuating a drive device according to claim 14, further comprising a prior step in which the angle of rotation and/or the direction of rotation of the mobile organ is determined, and a step in which the sequence of vibrations to be applied to the movement and/or to the timepiece in order to achieve it is determined.
